(19) United States
(12) Patent Application Publication
(10) Pub. No.: US 2007/0044721 A1
(43) Pub. Date: Mar. 1, 2007

(54) In ovo injection delivery device with integrated pump and injection needle

(75) Inventor: Robert L. Ilich, Wake Forest, NC (US)

Correspondence Address: MYERS BIGEL SIBLEY & SAJOVEC, PO BOX 37428, RALEIGH, NC, 27627, US

(73) Assignee: Embrex, Inc.

(21) Appl. No.: 11/508,072

(22) Filed: Aug. 22, 2006

Related U.S. Application Data
(60) Provisional application No. 60/711,293, filed on Aug. 25, 2005.

(51) Int. Cl. A01K 45/00

(52) U.S. Cl. 119/6.8

(57) ABSTRACT

In ovo injection delivery devices include a housing; an extendable and retractable injection needle movably disposed within the housing, wherein the needle is configured to deliver a predetermined dosage of a substance into an egg; and a pump assembly disposed within the housing, wherein the pump assembly is configured to deliver a predetermined amount of a substance to the needle for injection into an egg. A pneumatic logic circuit controls the injection needle and pump assembly via pressurized air or other fluid. The pneumatic logic circuit controls priming of the pump assembly with a substance when the injection needle is in a retracted position and controls dispensing of the substance from the pump assembly to the injection needle when the injection needle is in an extended position. A sensor that detects the presence of an egg within an egg flat (or other carrier) beneath the in ovo injection delivery device.

### RELATED APPLICATION

This application claims the benefit of and priority to U.S. Provisional Patent Application No. 60/711,293, filed Aug. 25, 2005, the disclosure of which is incorporated herein by reference as if set forth in its entirety.

### FIELD OF THE INVENTION

The present invention relates generally to eggs and, more particularly, to apparatus for processing eggs.

### BACKGROUND OF THE INVENTION

In many instances it is desirable to introduce a substance, via in ovo injection, into a live avian egg prior to hatch. Injections of various substances into avian eggs are typically employed in the commercial poultry industry to decrease post-hatch mortality rates and/or increase growth rates of hatched birds. Examples of substances that have been used for, or proposed for, in ovo injection include vaccines, antibiotics and vitamins. Examples of in ovo treatment substances and methods of in ovo injection are described in U.S. Pat. No. 4,458,630 to Sharma et al. and U.S. Pat. No. 5,028,421 to Fredericksen et al.

In ovo injections of substances typically occur by piercing the egg shell to create a hole therethrough (e.g., using a punch, drill, etc.), extending an injection needle through the hole and into the interior of the egg (and in some cases into the avian embryo contained therein), and injecting the treatment substance through the needle via a peristaltic or diaphragm-style pump that is separate (i.e., physically separate and separately controlled) from the injection needle apparatus. An example of an in ovo injection device is disclosed in U.S. Pat. No. 4,681,063 to Hebrank; this device positions an egg and an injection needle in a fixed relationship to each other, and is designed for the high-speed automated injection of a plurality of eggs.

In ovo injection devices conventionally utilize solenoid-driven diaphragm pumps or peristaltic-style pumps for selectably dispensing vaccine or other substances into eggs. Unfortunately, these pumps may be costly to maintain and replace, may be difficult to clean, and may not dispense vaccines or other substances with accuracy and/or consistency. Moreover, these pumps are conventionally designed to dispense a specific volume and may not allow for different (for example greater) volumes to be dispensed. In addition, vaccine dispensing manifolds are typically required which can be complex to produce and difficult to clean.

Because the substance pumping system is separate from the injection needle in conventional in ovo injection devices, these devices can be somewhat complex and difficult to operate and control, which can hinder egg processing speeds. In addition, conventional in ovo injection devices are configured to dispense a treatment substance via each injection needle apparatus whether an egg is present or not. As such, if an egg is missing in a pocket of an egg flat, a treatment substance dispensed via the injection needle apparatus corresponding to that egg flat pocket is wasted. As such, improved in ovo injection devices that are less complex than conventional devices and that facilitate conservation of treatment substances are desirable.

### SUMMARY OF THE INVENTION

In view of the above discussion, in ovo injection delivery devices are provided wherein an injection assembly is combined with a pump assembly. According to some embodiments of the present invention, an in ovo injection delivery device includes a housing; an extendable and retractable injection needle movably disposed within the housing, wherein the needle is configured to deliver a predetermined dosage of a substance into an egg; and a pump assembly disposed within the housing, wherein the pump assembly is configured to deliver a predetermined amount of a substance to the needle for injection into an egg. The in ovo injection delivery device may include a pneumatic logic circuit that controls the injection needle and pump assembly via pressurized air or other fluid. The pneumatic logic circuit controls priming of the pump assembly with a substance when the injection needle is in a retracted position and controls dispensing of the substance from the pump assembly to the injection needle when the injection needle is in an extended position.

According to some embodiments of the present invention, an in ovo injection delivery device includes a sensor that detects the presence of an egg within an egg flat (or other carrier) beneath the in ovo injection delivery device. The sensor may be a mechanical sensor and/or an electrical sensor.

### BRIEF DESCRIPTION OF THE DRAWINGS

FIGS. 1-6 are cross-sectional illustrations of an in ovo injection delivery device, according to some embodiments of the present invention.

FIGS. 7A-7B are enlarged partial views of a sensor that detects the presence of an egg within an egg flat beneath the in ovo injection delivery device of FIGS. 1-6, according to some embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines are used for clarity to indicate continuation, and may illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

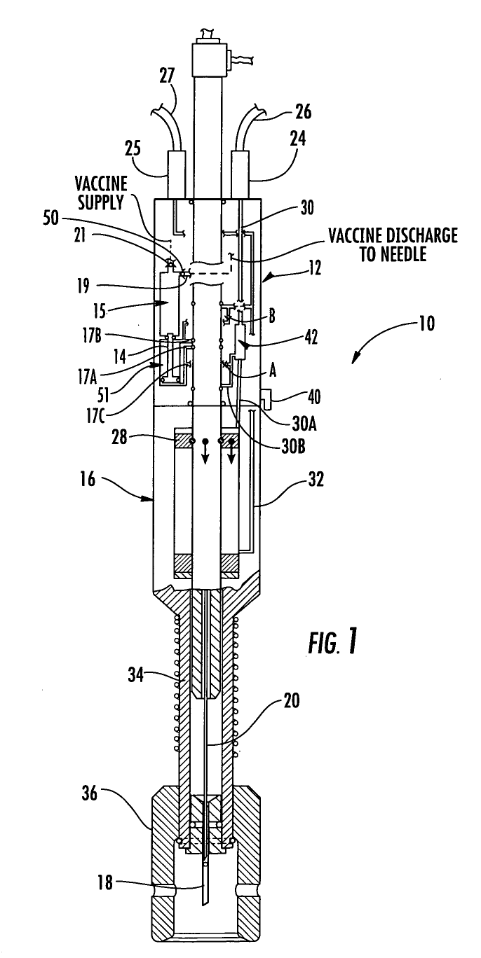

FIGS. 1-6 illustrate an in ovo injection delivery device 10, according to some embodiments of the present invention, that combines an in ovo injection tool and a substance delivery pump into a compact apparatus. The illustrated injection delivery device 10 includes a pump assembly 12 that contains a pump piston 14 reciprocally disposed within a cavity 15 and an injection assembly 16 that contains a punch and injection needle for delivering a substance into an egg. The punch 18 surrounds the needle 20 in coaxial relationship therewith.

The illustrated pump assembly 12 operates in concert with the movement of the various components associated with the injection assembly 16 which drive needle and punch movement in reciprocal opposite directions between punch-down/punch-up and extended/retracted needle, respectively. The illustrated pump assembly 12 includes a respective pair of air entry fittings 24, 25 which are connected to respective air supply lines 26, 27.

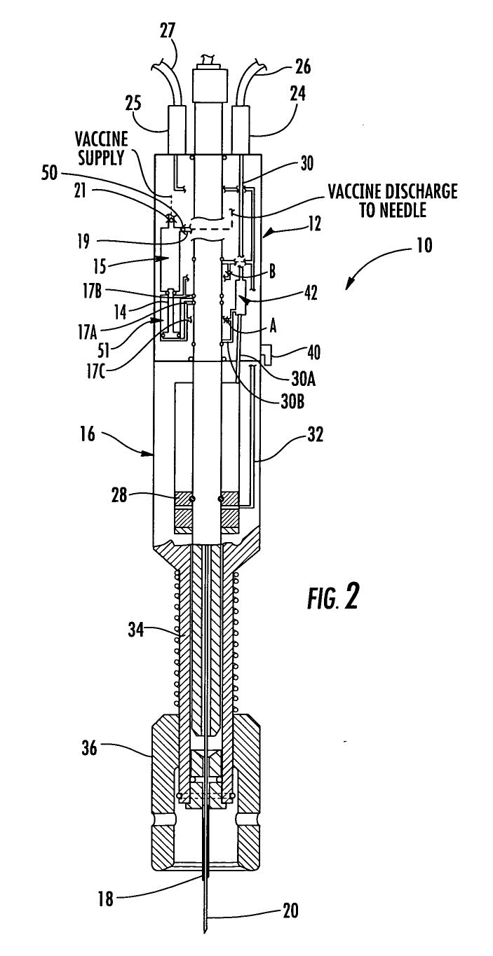

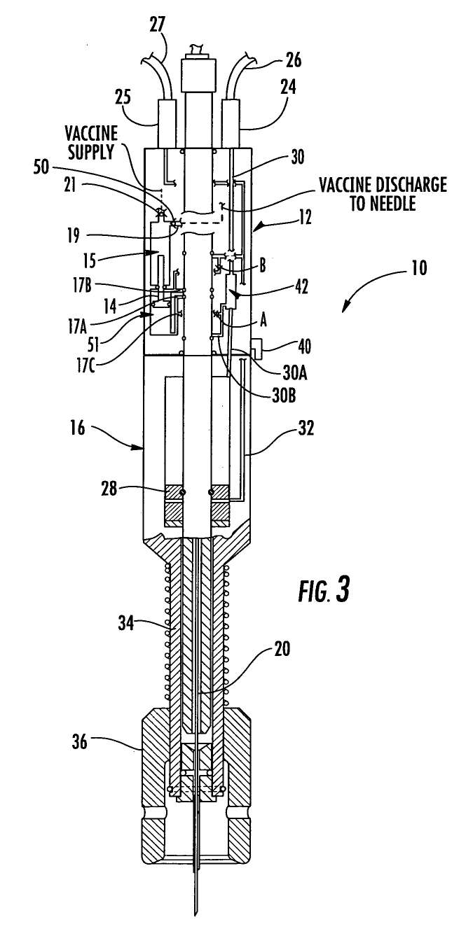

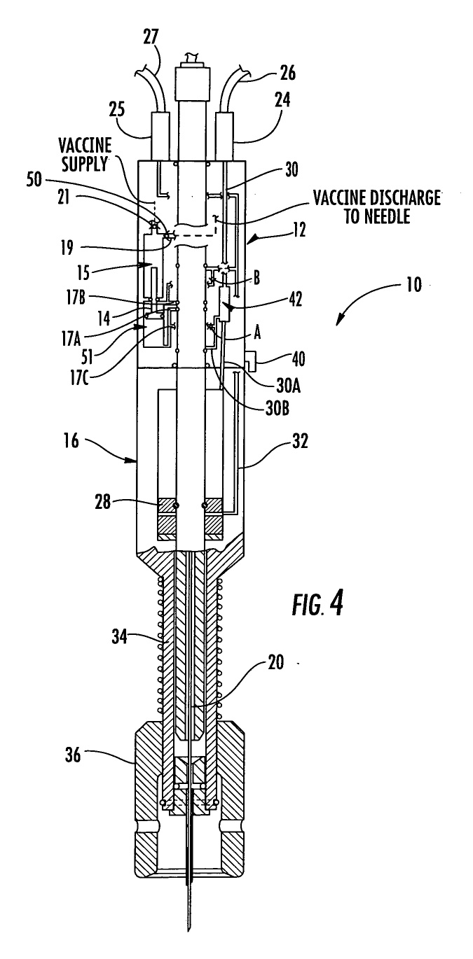

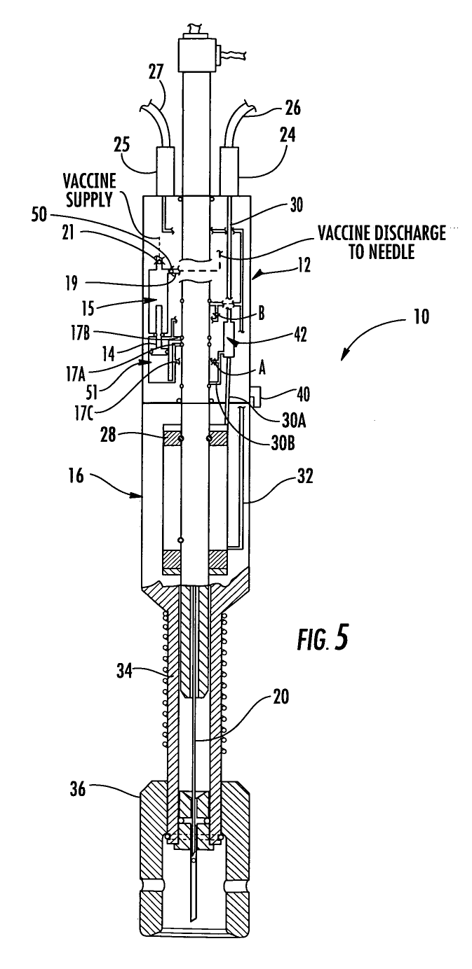

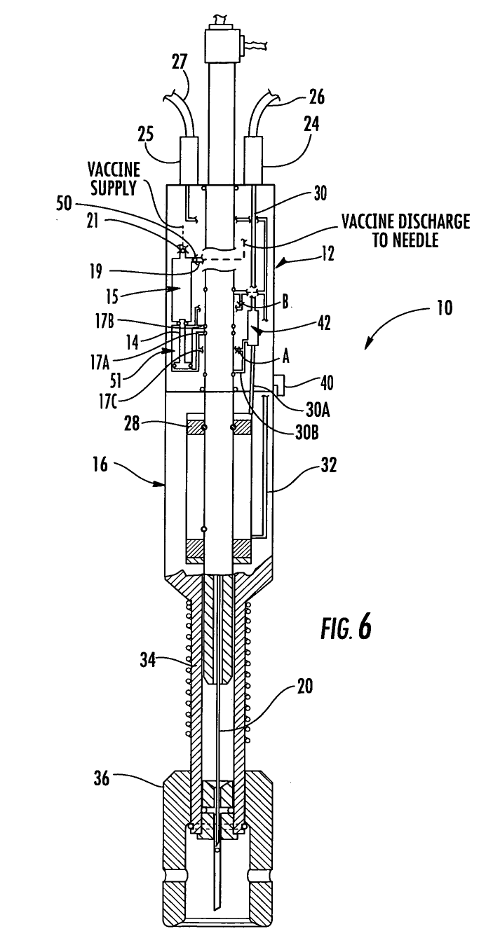

FIG. 1 illustrates the injection needle 20 in a retracted position, but charged with fluid and ready to inject an egg upon being extended into an egg as described herein. FIG. 2 illustrates the injection needle 20 in an extended position, such as it would be in when inserted in ovo, ready to inject a fluid. FIG. 3 illustrates movement of the pump piston 14 upwardly which dispenses fluid out of the pump cavity 15 through the fluid outlet port 19 and through the extended needle 20. FIG. 4 illustrates the injection delivery device 10 after dispensing of fluid through the injection needle 20. Air to retract the extended needle 20 is supplied through air entry fitting 25 and air passageway 32 to force piston 28 upwardly to retract the needle 20. FIG. 5 illustrates the needle 20 in a fully retracted position. Air is rerouted to the re-charge side of the pump piston 14 through air passageway port 17B. FIG. 6 illustrates the pump piston 14 moving downwardly as a result of air flow into the cavity 51 via port 17B. Downward movement of the pump piston 14 draws fluid into the pump cavity 15 via inlet port 21.

Operations of the illustrated in ovo injection delivery device 10 will now be described in greater detail. To drive the needle 20 downwardly so as to be in position to inject an egg, air is directed into the air entry fitting 24 via air supply line 26 through an opening in the pump assembly 12. The air flows through the injection assembly 16 via air passageway 30 and drives a piston 28. At the bottom of the piston stroke, and to desirably return the needle 20 to a retracted position, air is directed in through air entry fitting 25 via air supply line 27 and flows through the pump assembly 12 via air passageway 32 and drives the piston 28 back upwardly.

The use of a double acting cylinder, rather than a cylinder with a spring or other kind of biased return, provides the opportunity to make a more compact apparatus and to drive the punch 18 and needle 20 in a more controlled fashion. It will be understood, however, that other injection devices having, for example, a single stroke cylinder with a mechanically biased return, solenoid devices, or hydraulic devices, could be used in some embodiments of the present invention. Embodiments of the present invention are not limited to the illustrated pump and injection device.

The injection assembly 16 of the illustrated injection delivery device 10 includes a cylindrical punch guide 34 which surrounds the punch 18 and the needle 20. An egg locator 36, which slides on the punch guide co-axially, extends below the needle 20 and punch 18 when the needle 20 and punch 18 are in a retracted position and non-punch position, respectively. When the needle 20 and punch 18 are in the injecting position the needle 20 extends below the egg locator 36 while the punch 18 extends to a lower position with respect to the egg locator 36. In the illustrated embodiment, there is no relative motion of the punch 18 to the punch guide 34. When punching occurs, the egg locator 36 slides up the punch guide 34 while the injection delivery device 10 moves downwardly. The illustrated egg locator 36 which slides on the punch guide 34 forms an egg receiving cup. The egg locator 36 facilitates translational movement of the injection delivery device 10 relative to an egg and to mechanisms (e.g., tooling plates, etc.) associated with raising and lowering the injection delivery device 10 relative to a flat of eggs.

According to some embodiments of the present invention, the body of the injection assembly 16 is made of, for example, chemically resistant plastic that provides for extended internal and external wear resistance to prolong the life thereof and interfacing injector tooling plate components. The plastic body also provides simple re-work of the surface to restore correct surface finish for gripping as wear occurs. The lower half of the illustrated injection assembly 16 is also made of, for example, chemically resistant plastic and may be a separate or integrated component of the injection assembly 16. The lower half of the injection assembly 16 and the mating punch 18 provide the delivery path for sanitizing the needle 20 and punch 18 for the injection process and provides compliant attachment of the spring and locating cup 36 for locating to an egg.

An exemplary injection assembly device that may be modified to include an integral substance delivery pump, according to embodiments of the present invention, is the injection tool described in U.S. Pat. No. 5,136,979 and which is utilized by the Inovoject® egg injection system and available from Embrex, Inc., Durham, N.C.

The pump assembly 12 can be made from various materials without limitation. Exemplary materials include, but are not limited to, chemically resistant plastic, stainless steel, ceramics, etc. As illustrated, the pump assembly 12 is attached to the injection assembly 16. The pump assembly 12 houses the pneumatic logic circuit that routes air to the pump piston 14 that is housed within the pump assembly 12 when the injection needle 20 is at an end of its stroke (i.e., in an extended or retracted position). Priming of the pump (i.e., loading of a fluid into the cavity 15, FIGS. 5-6) and dispense of a substance from the cavity 15 via the pump piston 14 (FIGS. 2-3) is valve controlled using the end of stroke in the retracted needle position (FIG. 5) to prime (FIGS. 5-6) and the extended needle position (FIG. 2) to dispense the substance (FIGS. 2-3). Substance flow is checked at the inlet 21 and outlet 19 to the pump cavity 15 by, for example, duckbill check valves. The duckbill check valves remain open for system cleaning when the needle 20 is in either a retracted or extended position, according to some embodiments of the present invention.

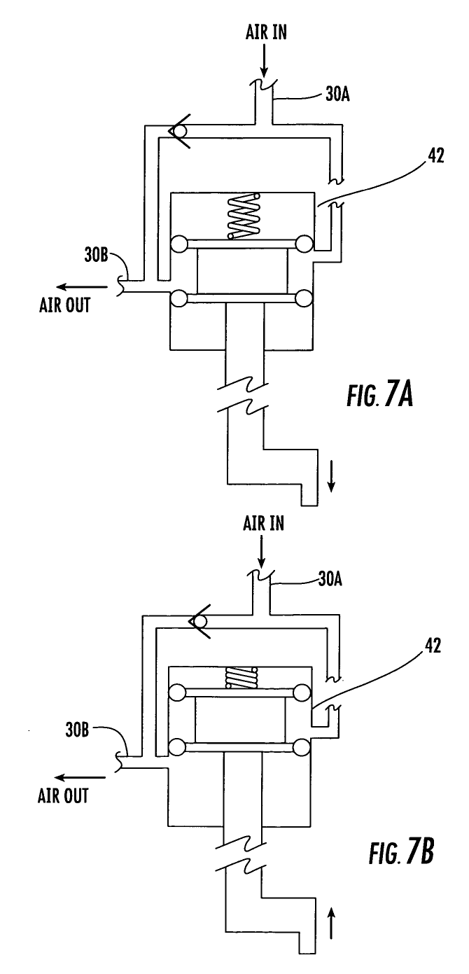

An optional sensor 40 for detecting the presence of an egg within a pocket of an egg flat (or other type of egg carrier) may be provided on the in ovo injection delivery device 10, according to some embodiments of the present invention. The sensor 40 generates an electrical or mechanical signal that indicates whether an egg is present or not and transmits the signal electrically or mechanically to a pneumatic logic circuit. The pneumatic logic circuit then controls air supply from air fitting 24 to the injection assembly 16 which in turn controls needle 20 extend and vaccine dispense via pump piston 14 and cavity 15 to the injection needle 20 upon receiving a signal that an egg is present beneath the respective injection delivery device 10. As the injection delivery device 10 begins to disengage from a tooling plate (i.e., a plate or other device that lowers the injection delivery device 10 onto an egg as described, for example, in U.S. Pat. No. 5,136,979), air flow for injection and dispense is enabled by opening the valve 42 to allow air flow from a system air control valve (FIG. 7A) to the lower portion 16 above the piston 28 for needle extension with substance dispense at end of stroke (FIGS. 2-3) or needle retract and substance prime at full retracted position (FIGS. 5-6). This valve 42 is closed when the injection delivery device 10 is disengaged from an egg and is resting on the tooling plate, as depicted in FIG. 7B, or opened when the injection deliver device 10 is engaged with an egg and lifted off of the tooling plate as shown in FIG. 7A.

Operation of the illustrated sensor 40 is now described in more detail. This sensor 40 is activated as the injection delivery device 10 contacts an egg. At rest and with no egg present in a pocket of a flat, the illustrated sensor 40 is in contact with a tooling plate that raises and lowers the injection delivery device 10, and an air supply circuit valve 42 is closed (FIG. 7B). If an egg is present within a pocket of a flat, as the injection delivery device 10 is lowered onto an egg, the tooling plate(s) continue to move downward until it disengages from the injection delivery device 10 such that the egg locator 36 rests upon the egg. As the injection delivery device 10 disengages from the tooling plate, the sensor 40 that was in contact with the tooling plate disengages therefrom and is free to travel downward, as indicated in FIG. 7A. As the sensor 40 moves downward from the closed position (FIG. 7B), the piston moves downward and opens the valve 42 routing air through the valve 42 as shown in FIG. 7A. Air at the supply inlet 30A freely flows through the valve 42 to the air outlet 30B.

At full needle extension, air is routed via air passage 17A to the extend side of the pump piston 14 (FIGS. 2-3) to pressurize for vaccine dispense. As the pump piston 14 moves forward (FIG. 3), it provides displacement of the fluid through the discharge side of the pump cavity, through the check valve 50 and up to the injection needle 20 by way of an external port and vaccine tube. At the end of dispense, air supply to port 24 by way of tubing 26 is shut off. The air supply valve remains open due to engagement of the injection delivery device 10 with an egg. This provides a path for air discharge during the recharging of the pump piston 14 through air passage 17C. This passage is limited for discharge only by the presence of a check valve A. Air passage 17D on the prime side of the pump cavity 51 (FIG. 3) provides a path for air discharge during the dispense cycle of the pump piston 14. The air supply valve 42 (FIGS. 7A-7B) remains open until the injection delivery device 10 disengages from an egg and rests on the tooling plate.

Air supply to port 25 by way of tubing 27 is turned on to retract the needle and at full needle retract, air is re-routed to the retract side or priming side of the pump piston 14 by way of air passage 17B. As the pump piston 14 begins to retract or move to the primed position, vaccine is drawn into the pump cavity 15 through the check valve at 21 and is ready for the next injection delivery.

In ovo injection delivery devices having integrated pump assemblies and injection needles, according to embodiments of the present invention, reduce the components associated with an in ovo injection apparatus, and thus the complexity associated with operation of an in ovo injection apparatus. In ovo injection delivery devices incorporating a device for detecting the presence of an egg therebeneath can provide cost savings because a substance is not dispensed if an egg is not present beneath a corresponding injection delivery device.

Embodiments of the present invention provide a unique approach of using common air supplied to the injector tooling cylinder and routes the air supply at the end of needle stroke to actuate an integrated pneumatic pump to deliver a vaccine or other substance. Previous systems have used dual devices operated and located remotely from each other creating greater cavity volumes for wasted vaccine and other substances, more complex vaccine (and other substance) manifolds, more complex pumping controls and support equipment.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An in ovo injection delivery device, comprising:
a housing;
an extendable and retractable injection needle movably disposed within the housing, wherein the needle is configured to deliver a predetermined dosage of a substance into an egg; and
a pump assembly disposed within the housing, wherein the pump assembly is configured to deliver a predetermined amount of a substance to the needle for injection into an egg.

2. The device of claim 1, further comprising a pneumatic logic circuit that controls the injection needle and pump assembly via pressurized air.

3. The device of claim 2, wherein the pneumatic logic circuit controls priming of the pump assembly with a substance when the injection needle is in a retracted position and controls dispensing of the substance from the pump assembly to the injection needle when the injection needle is in an extended position.

4. The device of claim 1, further comprising a sensor that detects the presence of an egg beneath the in ovo injection delivery device.

5. The device of claim 4, wherein the sensor comprises a mechanical sensor.

6. The device of claim 4, wherein the sensor comprises an electrical sensor.

7. An in ovo injection apparatus, comprising:
an egg carrier that holds a plurality of eggs and provides external access to the eggs;
a plurality of injection delivery devices positioned above the carrier, wherein each injection delivery device is configured to contact a respective egg in the carrier and deliver a predetermined dosage of a substance into the egg, wherein each injection delivery device comprises:
a housing;
an extendable and retractable injection needle movably disposed within the housing, wherein the needle is configured to deliver a predetermined dosage of a substance into an egg; and
a pump assembly disposed within the housing, wherein the pump assembly is configured to deliver a predetermined amount of a substance to the needle for injection into an egg.

8. The apparatus of claim 7, wherein each injection delivery device further comprises a pneumatic logic circuit that controls both the injection needle and pump assembly.

9. The apparatus of claim 8, wherein the pneumatic logic circuit for each injection delivery device primes the respective pump assembly with a substance when the respective injection needle is in a retracted position and allows the substance to be dispensed by the pump assembly to the injection needle when the injection needle is in an extended position.

10. The apparatus of claim 8, wherein each injection delivery device further comprises a sensor that detects the presence of an egg beneath the in ovo injection delivery device, wherein the sensor generates a signal that indicates whether an egg is present or not and transmits the signal to the pneumatic logic circuit, and wherein the pneumatic logic circuit only delivers a substance the injection needle upon receiving a signal that an egg is present beneath the respective in ovo injection delivery device.

11. The apparatus of claim 10, wherein the sensor comprises a mechanical sensor.

12. The apparatus of claim 10, wherein the sensor comprises an electrical sensor.
